(19) United States
(12) Patent Application Publication
(10) Pub. No.: US 2003/0105699 A1
(43) Pub. Date: Jun. 5, 2003

(54) Technique for calculating and displaying securities options data to produce a visual pattern of potential future values

(76) Inventor: Richard Redpath, Cary, NC (US)

Correspondence Address: RICHARD REDPATH, 109 BLYTHEWOOD COURT, CARY, NC, 27513, US

(21) Appl. No.: 10/006,003

(22) Filed: Dec. 3, 2001

(51) Int. Cl. G06F 17/60

(52) U.S. Cl. 705/36

(57) ABSTRACT

A technique is provided for providing securities options data in visual format. Stock options are securities that can be bought and sold that are related to a specific stock. Stock options expire at a certain date and are set at a certain strike price. The value of the option is dependent on a number of factors, including the price of the stock, the volatility of the stock price, interest rates, and the amount of time remaining until the option expires. The present invention provides a technique for displaying projected values of a stock option over time, with a user being able to manipulate the factors, so as to display to the user potential option prices over time based on different criteria while including the time until expiration factor. Certain of the data, such as a current stock price or option price, can be downloaded from a quote server. A user may input possible future prices of the stock or to view how it effects the value of the option, or input a desired future price of the option to project what the value of the underlying option must be to realize the desired future option price. Preferably, this data is displayed in a graphical format to the user. Data for more than one option may be displayed at the same time.

### BACKGROUND OF THE INVENTION

1. Field of the Invention

The present invention relates to data processing systems and, in particular, to a system for calculating and displaying information about securities options. Still more particularly, the present invention provides a method, apparatus, and program for visually displaying data regarding one or more securities options simultaneously, the data preferably being displayed to create patterns that can be easily understood by users to assist them in making decisions regarding the purchase and sale of the options.

2. Background of the Invention

A security option is a contract with an expiration date for a proxy to buy or sell a stock at a defined exercise price. As is well known, the price to pay for a contract at a given point in time, called the premium, is determined by the Black-Scholes formula. The Black-Scholes formula values an option based on a number of factors, including the current stock price (for the stock to which the option is related), time until the option expires, the strike price of the option, the volatility of the stock, the prevailing interest rate.

While a current price for a stock option can be downloaded from a quote server via the Internet, what is often difficult for an options trader to determine is exactly how future possible changes in the value of the stock over time will affect the value of the option. Typically, a trader will not hold the option until expiration (and thus have to buy or sell the underlying stock itself), but will buy and sell the option prior to expiration to exploit changes in the value of the stock in order to make a profit. Today, many traders rely on experience to judge how future stock price changes will affect the value of the option, or use tools having very limited capabilities which are quite difficult to use.

Additionally, advanced option traders employ the purchase and sale of combinations of options (calls and puts) for a given stock in a wide variety of strategies for general market directions in order to make a profit. Determining profitable entry and exit points for a combination strategy is highly computational, and extremely difficult to calculate correctly and understand. But, once again, tools that would make this easily understood simply do not exist.

Therefore, it would be advantageous to provide a mechanism to visually display information for a single option and for a set of securities options data to determine risk and reward by producing visual patterns that can be easially recognized by a human.

### SUMMARY OF THE INVENTION

The present invention provides a mechanism for visually displaying one or more securities options data. This mechanism provides a means to visually display combinations of securities options to determine risk and reward by producing visual patterns that can be easily recognized by a human.

More specifically, the present invention provides a computer implemented method for displaying securities option data, comprising the steps of calculating projected values for an option for a period of time based on option valuation criteria; and displaying the calculated values for the option during at least a portion of the period of time. The displaying step may further comprise displaying the calculated values in a graph format and the period of time is from a current date until expiration of the option. Additionally, the displaying step may further comprise displaying the calculated value as a single value for each day until expiration of the option. The displaying step may further comprise displaying at least some of the option valuation criteria, and the method may further comprise the steps of permitting a user to modify at least one of the option valuation criteria; recalculating the projected values for the option based on the modified option valuation criteria; and displaying the recalculated projected values for the option.

Additionally, the method may further comprise the steps of calculating projected values for a second option for the period of time based on option valuation criteria; and displaying the calculated values for the second option simultaneously with the projected values for the first option. The option valuation criteria may include a current value of the option, a current value of a security that the option is related to, a volatility factor and an interest rate factor. The modified option valuation criteria may be a selected future value for a security that the option is related to, and the projected values of the option can be recalculated based on the security having the selected future value. The modified option valuation criteria may be a selected desired value for the option, and projected values of a security that the option is related to can be calculated based on the option having the selected future value and the projected values of the security may then be displayed.

The method may further comprise the steps of permitting a user to input a desired value for the option; calculating projected values of the security related to the option over time that will provide the desired value for the option over the period of time; and displaying the projected value of the security during at least a portion of the period of time. Further, the displaying step may display the calculated values in visual patterns that indicate risk and reward.

The present invention may also provide a system in a computing environment for calculating and displaying securities option data, the system comprising means for calculating projected values for an option for a period of time based on option valuation criteria; and means for displaying the calculated values for the option during at least a portion of the period of time. The calculated values may be displayed with a single calculated value displayed for each business day in the portion of the period of time. The displaying means may further comprise means for displaying the calculated values in a graph format and the period of time may be from a current date until expiration of the option. Additionally, the displaying means may further comprise displaying the calculated value as a single value for each day until expiration of the option.

Still further, the displaying means may comprise displaying at least some of the option valuation criteria, and the system may further comprise means for permitting a user to modify at least one of the option valuation criteria; means for recalculating the projected values for the option based on the modified option valuation criteria; and means for displaying the recalculated projected values for the option. Also, the system may further comprise means for calculating projected values for a second option for the period of time based on option valuation criteria; and means for displaying the calculated values for the second option simultaneously with the projected values for the first option.

The option valuation criteria may include a current value of the option, a current value of a security that the option is related to, a volatility factor and an interest rate factor. The modified option valuation criteria may be a selected future value for a security that the option is related to, and the projected values of the option can be recalculated based on the security having the selected future value. The modified option valuation criteria may be a selected desired value for the option, and projected values of a security that the option is related to may be calculated based on the option having the selected future value and the projected values of the security may be displayed. The system may further comprise means for permitting a user to input a desired value for the option; means for calculating projected values of the security related to the option over time that will provide the desired value for the option over the period of time; and means for displaying the projected value of the security during at least a portion of the period of time.

The invention also provides processes embodied in computer readable code for processing by a computer for calculating and displaying securities option data, the code comprising first processes for calculating projected values for an option for a period of time based on option valuation criteria; and second processes for causing the calculated values for the option to be displayed during at least a portion of the period of time. The computer readable code may further comprise third processes for calculating projected values for a second option for the period of time based on option valuation criteria; and fourth processes for displaying the calculated values for the second option simultaneously with the projected values for the first option.

### BRIEF DESCRIPTION OF THE DRAWINGS

The novel features of the invention are set forth in the appended claim. The invention itself, however, as well as a preferred mode of use, further objectives and advantages thereof, will best be understood by reference to the following detailed description of an embodiment when read in conjunction with the accompanying drawings, wherein:

FIG. 1 depicts a pictorial representation of a network of data processing systems in which the present invention may be implemented;

FIG. 2a is a flowchart illustrating the process mechanism in accordance with the preferred embodiment of the present invention.

FIG. 2b is a flowchart illustrating the process mechanism in accordance with the preferred embodiment of the present invention.

FIG. 3 is a flowchart for a user defining the predicted stock value for an option view day.

FIG. 4 is a flowchart for a user computing the premium for an option for an option view day.

FIG. 5 is a flowchart implementing the invention to a securities option strategy.

FIG. 6 depicts a pictorial representation of a visual pattern as a result of implementation of the invention.

FIG. 7 depicts a pictorial representation as a result of implementation of the invention for a constant premium to show projected values of a security.

FIG. 8 depicts a pictorial representation as a result of implementation of the invention for a defining a predicted stock value to show visually projected values of premiums for one or more securities.

### DETAILED DESCRIPTION OF THE PREFERRED EMBODIMENT

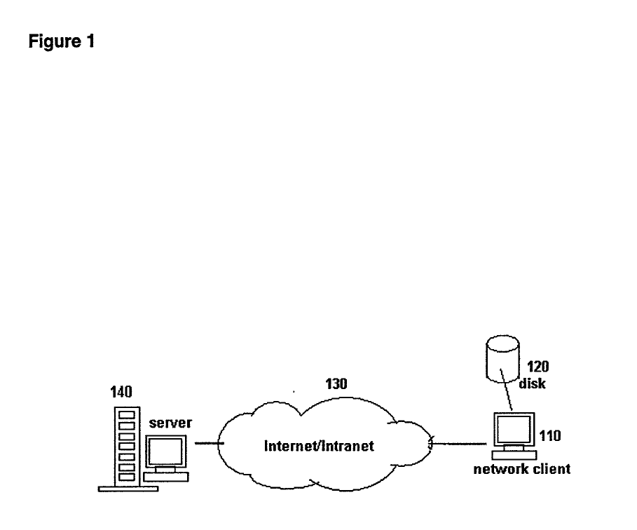

With reference now to the figures, FIG. 1 depicts a pictorial representation of a network of data processing systems. At 110 a client network machine (cell phone or computer) can receive over a network 130 from a server 140 a method, apparatus, or program to implement the embodiment. At 110 the client machine can load from disk 120 a method, apparatus, or program to implement the embodiment.

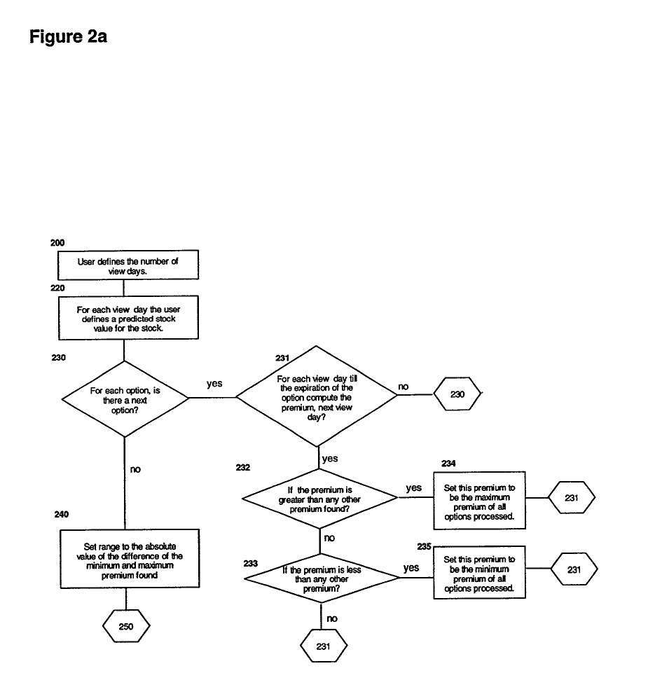

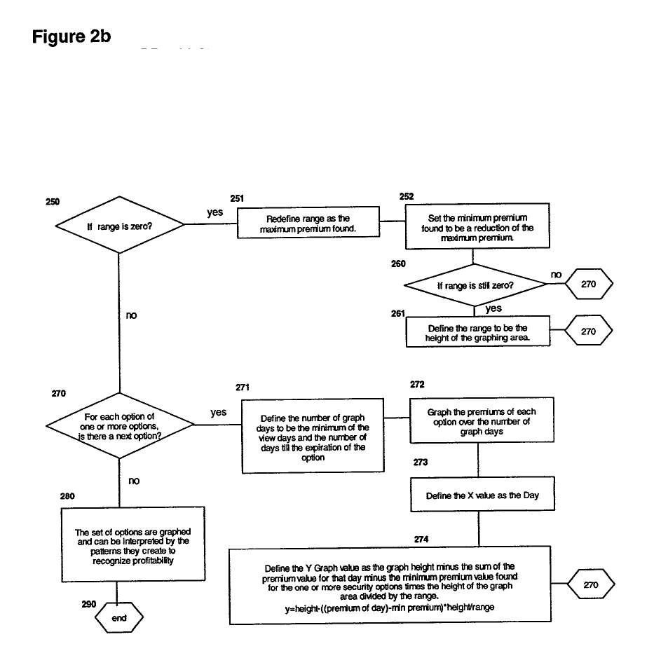

With reference now to FIG. 2a, illustrating the process mechanism in accordance with the preferred embodiment of the present invention. At 200, the user defines the number of view days in which the premium for one or more securities options data are to be viewed. A security option can range from 1 to 1500 days to expiration. The user could set the number of view days to 30 days. At 220, for each view day the user defines a predicted stock value for the underlying stock which effects the premium value of a security option for the one or more security options. At 230, for each security option of the one or more security options determine the premiums for all the view days of the option at step 231. At 230, If there are no more securities options then step 240. At 231, the premium is computed for each view day till the expiration of the security option using the predicted stock value for each view day then step 232. If there are no more option days at 231 then return to step 230. At 232, a determination is made if the premium is greater than any other premium found then at step 234 set this premium to be the maximum premium found then return to step 231. At step 232, if the premium not greater than any other premium found then continue to step 233. At 233, a determination is made if the premium is less than any other premium then at step 235 set this premium to be the minimum premium then return to step 231. At 233, if the premium is not less than another other premium then return to step 231. At step 231, after each security option of the set of securities options has computed the premiums then at 240, At 240, set the range to be the absolute value of the difference of the minimum and maximum premiums found then continue to step 250. With reference now to FIG. 2b, a determination is made at step 250. At 250, if the range is zero then step 251. At 250, if the range is not zero then step 270. At 251, redefine the range as the maximum premium found then at step 252 set the minimum premium found to be the reduction of the maximum premium. Typically this reduction is a factor of one half which is aesthetically pleasing but not necessary fixed. Then at 260, a determination is made, if the range is still zero then 261 the range is defined as the height of the graphing area then at 270. At 260, if the range is not still zero then step 270. At 270, for each security option of one or more security options then step 271, At 270, if there are no more security options to process then 280. At 271, define the number of graph days to be the minimum of the view days defined by the user and the number of days till the expiration of one or more security options then step 272. At 272, graph the premiums of each security option over the number of graph days, then step 273. At 273, define the X value for the graph X-axis as the graph day, then at 274 define the Y graph value for the Y-axis of the graph as the graph area height minus the sum of the premium value for that day minus the minimum premium value found (for one or more security options) times the height of the graph area divided by the range then return to 270. At 280, the set of securities options are graphed and can be interpreted by the patterns they create to recognize profitability the step 290 end.

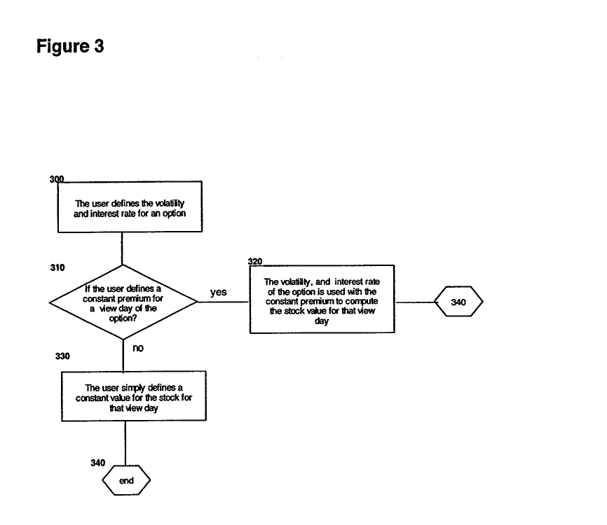

Referring to FIG. 3, for the preferred embodiment of the invention for defining the predicted stock value for a view day of an option. At 300 the user defines the volatility and interest rate for an option then step 310. At 310, a determination is made if the user defines a constant premium for the option view day then step 320. At 320, the volatility, and interest rate is used with the defined premium to compute the stock value for that option view day then step 340 end. At 310, If the user does not define a constant premium for a view day then step 330 the user simply defines a constant value for the stock for that view day then step 340 end.

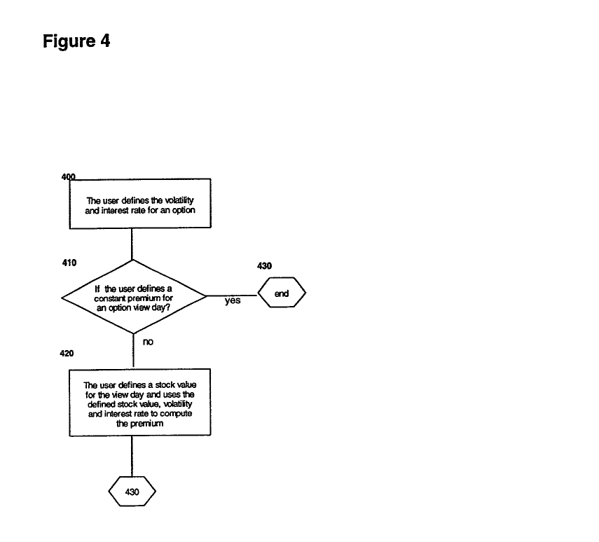

Referring to FIG. 4, for the preferred embodiment of the invention for computing the premium for a view day of an option. At 400, the user defines the volatility and interest rate for an option then step 410. At 410, a determination is made, if the user defines a constant premium for an option view day then step 430 end. At 410, if the user does not define a constant premium for an option view day then step 420. At 420, the user defines the stock value for an option view day which is used to compute the premium for that view day then step 430 end.

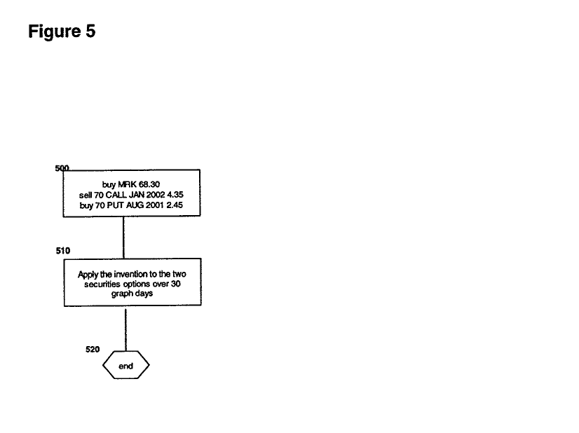

With reference now to FIG. 5, for implementing the embodiment to a security option strategy. At 500, the security MRK is purchased at 68.30, a 70 CALL JAN 2002 option is sold for 4.35, a 70 PUT AUG 2001 is purchased for 2.45. This strategy is called a Collar strategy which is a sell of a long CALL and a buy of a short PUT. At 510, the invention is applied to graph the two security options over 30 days then 520 end.

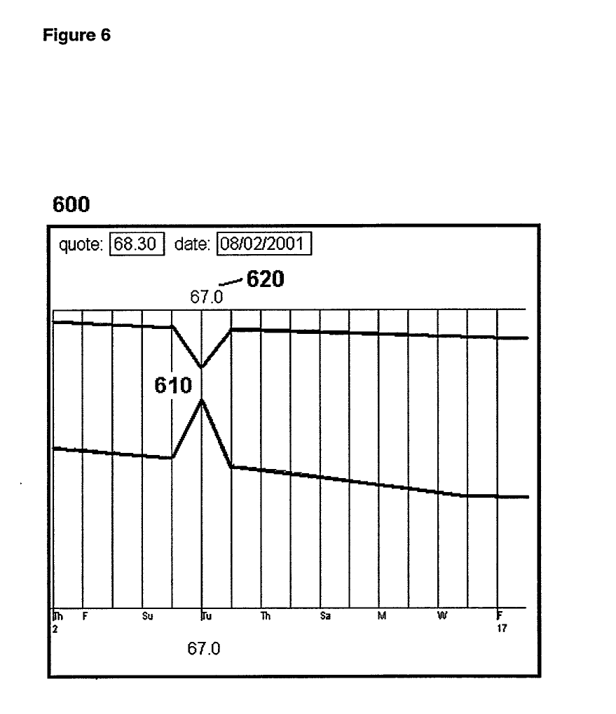

Referring to FIG. 6, the result of implementing the embodiment to a security option strategy from FIG. 5. At 600, the result of implementing the invention is a pattern showing a pinching of the two security option lines at 610 for a given predicted stock value of 67 at 620. This strategy is called a Collar strategy which is a sell of a long CALL and a buy of a short PUT. It is popular to protect a long position on a stock security and also provides some income leverage on the stock. The strategy is the following, a CALL is sold for an out-of-the-money position for the long position you are willing to accept as an investment hedge. A short PUT is purchased to protect the long position you have acquired which is significantly lower than the CALL price; with the difference you have a profit. If the market is bullish over the long run you will be called out of your position and have a hedge profit on the stock. If the market is bearish you will be compensated for the loss value on your stock. As a result of this invention, the start of a pinch shown at 610 indicates that the Collar strategy is becoming profitable to exit the obligation with a profit and still keep the security. This visual pattern at 610 is the first of its kind and very recognizable for determining profitability to exit the obligation.

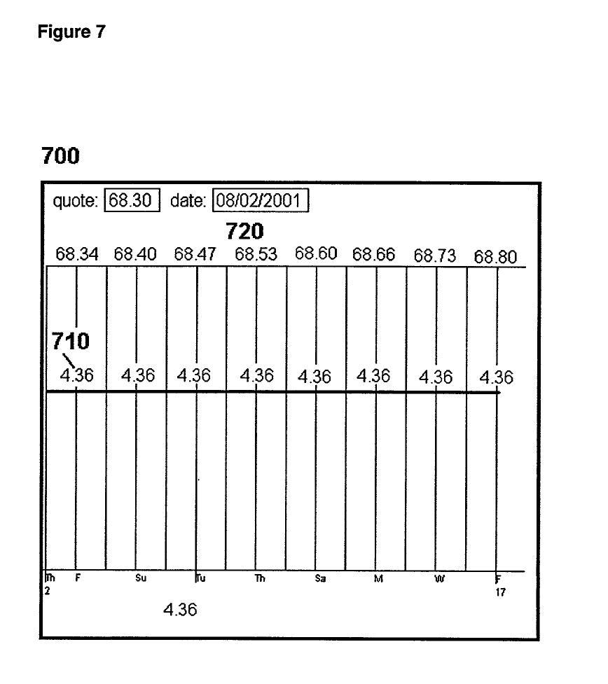

Referring to FIG. 7, the invention may further comprise means for permitting a user to input a desired value for the option; means for calculating projected values of the security related to the option over time that will provide the desired value for the option over the period of time; and means for displaying the projected value of the security during at least a portion of the period of time. At 700 the result of implementing the invention for a constant premium is shown. At 710, the constant premium value is shown as 4.36, the embodiment of the invention shows at 720 visually the projected values of the stock for this constant premium to occur over the view days.

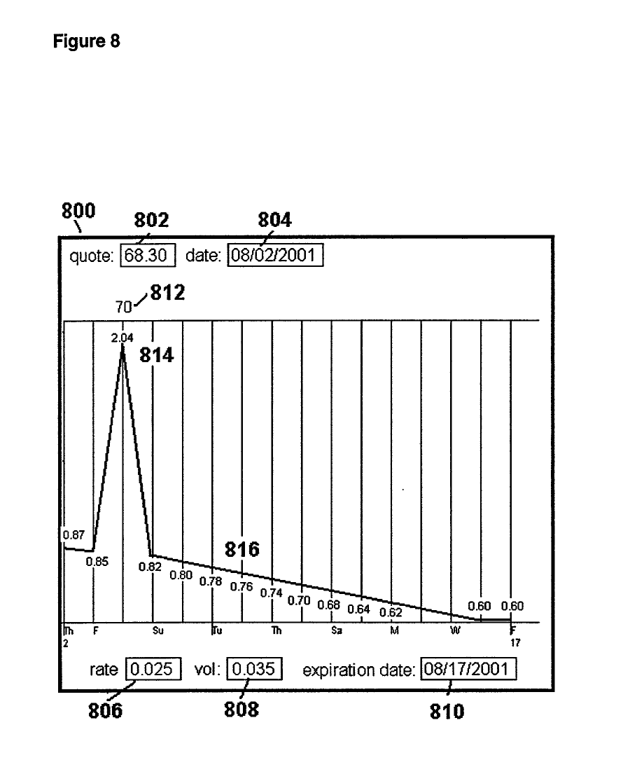

Referring to FIG. 8, for the preferred embodiment of the invention for defining the predicted stock value for a view day of an option to show a visual pattern of potential future values for one or more security options. At 800, a single security option is shown using the embodiment of the invention. At 802, the current stock price of the security for the option is a value of 68.30. At 804, the current start date for displaying the option is shown as 08/02/2001. At 806, the interest rate 0.025 is shown for computing the option. At 808, the implied volatility 0.035 is shown for computing the option. At 810, the expiration date 08/17/2001 of the option is shown. At 812, the user has set a predicted stock value of 70 for a view day. At 814, the computed premium is shown as a result of this predicted stock value. At 816, the computed premium is shown for each view day assuming the stock value is 68.30 at 802. FIG. 8, shows the basic display model of the embodiment of the invention for displaying one or more security options using a single security option as an example.

The description of the invention has been presented for purpose of illustration and description, it is not intended to be exhaustive or limited to the invention in the form disclosed. Many option strategies can be applied to using this invention which will produce distinctive visual patterns that can be used for determining profitability. The embodiment was chosen and described in order to best explain the principles of the invention, practical application, and to enable others of ordinary skill in the art to understand the invention for various embodiments with various modifications as are suited to the particular use contemplated.

What is claimed is:

1. A computer implemented method for displaying securities option data, comprising the steps of:
calculating projected values for an option for a period of time based on option valuation criteria; and
displaying the calculated values for the option during at least a portion of the period of time.

2. A method for displaying securities option data according to claim 1, wherein said displaying step further comprises displaying the calculated values in a graph format and the period of time is from a current date until expiration of the option.

3. A method for displaying securities option data according to claim 2, wherein said displaying step further comprises displaying the calculated value as a single value for each day until expiration of the option.

4. A method for displaying securities option data according to claim 1, wherein said displaying step further comprises displaying at least some of the option valuation criteria, said method further comprising the step of:
permitting a user to modify at least one of the option valuation criteria;
recalculating the projected values for the option based on the modified option valuation criteria; and
displaying the recalculated projected values for the option.

5. A method for displaying securities option data according to claim 1, further comprising the steps of:
calculating projected values for a second option for the period of time based on option valuation criteria; and
displaying the calculated values for the second option simultaneously with the projected values for the first option.

6. A method for displaying securities option data according to claim 1, wherein the option valuation criteria include a current value of the option, a current value of a security that the option is related to, a volatility factor and an interest rate factor.

7. A method for displaying securities option data according to claim 4, wherein the modified option valuation criteria is a selected future value for a security that the option is related to, and the projected values of the option are recalculated based on the security having the selected future value.

8. A method for displaying securities option data according to claim 1, wherein the modified option valuation criteria is a selected desired value for the option, and projected values of a security that the option is related to are calculated based on the opt ion having the selected future value and the projected values of the security are displayed.

9. A method for displaying securities option data according to claim 1, further comprising the steps of:
permitting a user to input a desired value for the option;
calculating projected values of the security related to the option over time that will provide the desired value for the option over the period of time; and
displaying the projected value of the security during at least a portion of the period of time.

10. In a computing environment, a system for calculating and displaying securities option data, said system comprising:
means for calculating projected values for an option for a period of time based on option valuation criteria; and
means for displaying the calculated values for the option during at least a portion of the period of time.

11. A system for calculating and displaying securities option data according to claim 10, wherein the calculated values are displayed with a single calculated value displayed for each business day in the portion of the period of time.

12. A system for calculating and displaying securities option data according to claim 10, wherein said displaying means further comprises means for displaying the calculated values in a graph format and the period of time is from a current date until expiration of the option.

13. A system for calculating and displaying securities option data according to claim 11, wherein said displaying means further comprises displaying the calculated value as a single value for each day until expiration of the option.

14. A system for calculating and displaying securities option data according to claim 10, wherein said displaying means further comprises displaying at least some of the option valuation criteria, said system further comprising:
means for permitting a user to modify at least one of the option valuation criteria;
means for recalculating the projected values for the option based on the modified option valuation criteria; and
means for displaying the recalculated projected values for the option.

15. A system for calculating and displaying securities option data according to claim 10, further comprising:
means for calculating projected values for a second option for the period of time based on option valuation criteria; and
means for displaying the calculated values for the second option simultaneously with the projected values for the first option.

16. A system for calculating and displaying securities option data according to claim 10, wherein the option valuation criteria include a current value of the option, a current value of a security that the option is related to, a volatility factor and an interest rate factor.

17. A system for calculating and displaying securities option data according to claim 14, wherein the modified option valuation criteria is a selected future value for a security that the option is related to, and the projected values of the option are recalculated based on the security having the selected future value.

18. A system for calculating and displaying securities option data according to claim 10, wherein the modified option valuation criteria is a selected desired value for the option, and projected values of a security that the option is related to are calculated based on the option having the selected future value and the projected values of the security are displayed.

19. A system for calculating and displaying securities option data according to claim 10, further comprising:
means for permitting a user to input a desired value for the option;
means for calculating projected values of the security related to the option over time that will provide the desired value for the option over the period of time; and
means for displaying the projected value of the security during at least a portion of the period of time.

20. A method for displaying securities options data according to claim 1, wherein said displaying step displays the calculated values in visual patterns that indicate risk and reward.

21. Computer readable code for processing by a computer for calculating and displaying securities option data, said code comprising:
first processes for calculating projected values for an option for a period of time based on option valuation criteria; and
second processes for causing the calculated values for the option to be displayed during at least a portion of the period of time.

22. Computer readable code for calculating and displaying securities option data according to claim 21, further comprising:
third processes for calculating projected values for a second option for the period of time based on option valuation criteria; and
fourth processes for displaying the calculated values for the second option simultaneously with the projected values for the first option.
